(19) United States
(12) Patent Application Publication
(10) Pub. No.: US 2023/0370004 A1
(43) Pub. Date: Nov. 16, 2023

(54) Motor Control System with Adjustable Voltage Harmonic and Method for Correcting the Motor Control System

(71) Applicant: FORCECON TECHNOLOGY CO., LTD., Zhubei City (TW)

(72) Inventors: Shih-Chieh WANG, Zhubei City (TW); Cheng-Tai CHENG, Zhubei City (TW); Ming-Ho HSU, Zhubei City (TW)

(21) Appl. No.: 17/744,957

(22) Filed: May 16, 2022

(51) Int. Cl. H02P 21/05; H02P 6/10; H02P 27/08

(52) U.S. Cl. CPC H02P 21/05; H02P 6/10; H02P 27/08

(57) ABSTRACT

A motor control system with adjustable voltage harmonic and method for correcting the motor control system is disclosed. Based on the input modulation order, the motor control system drives and controls a motor. The motor control system includes: a harmonic voltage weight selection unit, used to select weight values of the harmonic wave corresponding to the modulation order, a modulation signal selection unit, used to select the output pulse duty ratio modulation signal corresponding to the modulation order. Based on the weight values of the harmonic wave, the output pulse duty ratio modulation signal and the pulse modulation carrier frequency signal, a pulse modulation part generates a control signal. Based on the control signal, the inverter circuit adds the harmonic voltage into the motor-driving voltage that drives the motor, so as to improve the noise condition of the motor.

### CROSS-REFERENCE TO RELATED U.S. APPLICATIONS

Not applicable.

### BACKGROUND OF THE INVENTION

### 1. Field of the Invention

The present invention relates generally to a motor control system, and more particularly to a motor control system with adjustable voltage harmonic and a method for correcting the motor control system.

### 2. Description of Related Art Including Information Disclosed Under 37 CFR 1.97 and 37 CFR 1.98.

Torque ripple refers to the phenomenon of cyclic variation of the output torque during the operation of the motor. In an electric motor, the torque ripple often causes noises and vibrations. The torque ripple can be improved by controlling the operation of the motor through an appropriate voltage waveform.

The prior-art modulation of the pulse width technology can modulate the waveform of the phase voltage output by the motor into a sine wave. FIG. 1A and FIG. 1B depict the waveform curve of the seven-phase SVPWM (short for Space Vector Pulse-Width Modulation) conducted by the prior-art computer simulation technique, wherein Va, Vb and Vc are respectively the modulated terminal voltage waveform curves, Vas, Vbs and Vcs are respectively phase voltage waveform curves input for the motor. FIG. 2 depicts the waveform curve of the modulation of the pulse width conducted by the prior art when the duty ratio of the computer simulated modulation order is 75%, wherein Kea, Keb and Kec are respectively the opposing electromotive force constants, which are not distributed in a standard sine wave. This is a common phenomenon in the case of small motors. Ia, Ib and Ic are respectively phase currents, Te is the torque variation curve during operation of the motor. The prior art based on the principle of generating a sine wave phase voltage driving waveform still has some shortcomings in improving the phenomenon of torque ripple.

### BRIEF SUMMARY OF THE INVENTION

The main object of the present invention is to provide a motor control system with adjustable voltage harmonic and a method for correcting the motor control system.

In light of the above object, the present invention solves the existing problem through the main technical feature that the motor control system with adjustable voltage harmonic can drive and control a motor on the basis of the input modulation order, said motor control system comprising:
a harmonic voltage weight selection unit, including a first storage part and a first selection part, wherein, the first storage part is connected to the first selection part, the first storage part is used to store a plurality of weight values of the harmonic waves of the harmonic voltage, based on the duty ratio instructed by the modulation order, the first selection part selects the weight values of the harmonic wave corresponding to the harmonic voltage to be generated;
a modulation signal selection unit, said modulation signal selection unit including a second storage part and a second selection part, wherein said second storage part is connected to the second selection part, said second storage part is used to store a plurality of output pulse duty ratio modulation signals, based on the duty ratio instructed by the modulation order, the second selection part selects the corresponding output pulse duty ratio modulation signal;
a pulse modulation part, connected to the first selection part and the second selection part, which is used to receive the weight values of the harmonic wave and the output pulse duty ratio modulation signal, based on the weight values of the harmonic wave, the output pulse duty ratio modulation signal, and the externally input pulse modulation carrier frequency signal, a plurality of control signals are generated; and
an inverter circuit, connected to the pulse modulation part and the motor, wherein said inverter circuit includes a plurality of electronic power switches, and is used to receive the control signal, the electronic power switches are actuated based on the control signal, adding the harmonic voltage into the motor-driving voltage, so as to drive the motor to run;
wherein the weight values of the harmonic wave define the ratio between the voltage harmonic peak and the basic voltage frequency peak.

The method for correcting the motor control system can adapt the motor control system to a motor; said method including the following steps:
creating a correcting structure: The motor is configured with a first detector, the first detector is used to detect the vibration or noise of the running motor, and to generate a first operating signal, the first detector is connected to a correcting device, the motor control system includes a harmonic voltage weight selection unit, a modulation signal selection unit, a pulse modulation part and an inverter circuit, wherein the modulation signal selection unit and the harmonic voltage weight selection unit are respectively coupled with a generating device, the order generating device is used to generate a modulation order, the harmonic voltage weight selection unit is connected to the correcting device, the correcting device is used to adjust the selection of weight values of the harmonic wave corresponding to the modulation order, the harmonic voltage weight selection unit and the modulation signal selection unit are respectively connected to the pulse modulation part, the pulse modulation part is connected to the inverter circuit, the inverter circuit is connected to the motor, the harmonic voltage weight selection unit stores a plurality of weight values of the harmonic waves of the harmonic voltage, the harmonic voltage weight selection unit includes a first selection part, the first selection part is used to select the corresponding weight values of the harmonic wave based on the modulation order, based on the duty ratio instructed by the modulation order, the modulation signal selection unit is used to select the corresponding output pulse duty ratio modulation signal, based on the weight values of the harmonic wave, the output pulse duty ratio modulation signal, and the externally input pulse modulation carrier frequency signal, the pulse modulation part generates a plurality of control signals, based on the control signal, the inverter circuit drives the motor to run;
issuing a modulation order: the order generating device issues the modulation order to the motor control system;
detection: the first detector detects the vibration or noise of the running motor, and to generates the first operating signal;
checking motor operation state: based on the first operating signal, the correcting device judges if the vibration or noise performance of the motor meets the anticipation of the modulation order;
adjusting weight values of the harmonic wave selection: if the vibration or noise performance of the motor meets the anticipation of the modulation order, the correcting device maintains the selection of the harmonic voltage weight selection unit based on the weight values of the harmonic wave corresponding to the modulation order, if the vibration or noise performance of the motor does not meet the anticipation of the modulation order, the correcting device removes the selection of the harmonic voltage weight selection unit based on the weight values of the harmonic wave corresponding to the modulation order;
repeatedly executing the step to issue a modulation order, the detecting step, the step to check the motor operation state, and the selection step to modulate the weight of the harmonic wave, thus, the motor control system can be adapted to the motor;
wherein, when executing the selection step to modulate the weight of the harmonic wave, the selection of weight values of the harmonic wave by the harmonic voltage weight selection unit based on the modulation order is maintained, and the step to issue a modulation order is executed again, a different modulation order is issued to the motor control system;
when executing the selection step to modulate the weight of the harmonic wave, the selection of weight values of the harmonic wave by the harmonic voltage weight selection unit based on the modulation order is removed, and the step to issue a modulation order is executed again, the same modulation order is issued to the motor control system, thus, the weight values of the harmonic wave stored by the harmonic voltage weight selection unit is adjusted to be adapted to the modulation order.

The main efficacy and advantage of the invention is that it can reduce the noise and vibration of the motor by modulating the voltage waveform.

### BRIEF DESCRIPTION OF THE SEVERAL VIEWS OF THE DRAWINGS

FIG. 1A and FIG. 1B depict the waveform curves of the terminal voltages and phase voltages during modulation of the pulse width conducted by the prior art.

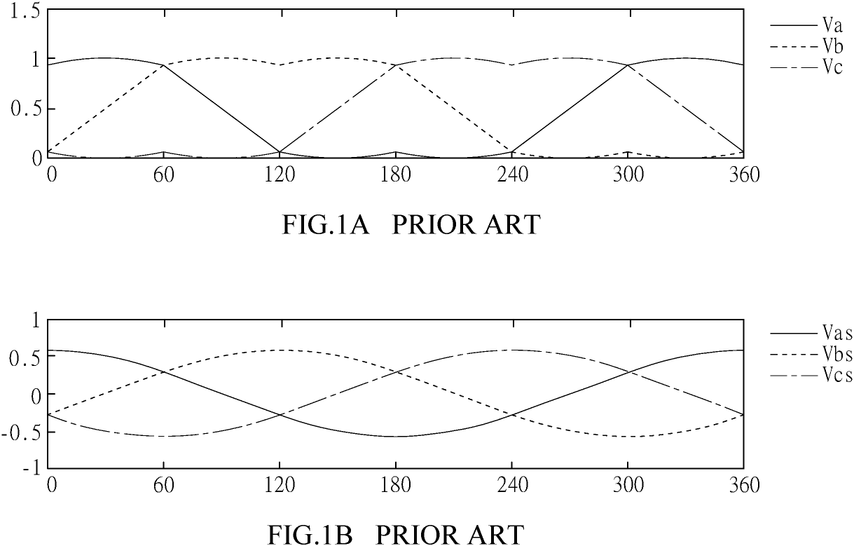

FIG. 2 depict the torque wave of the running motor during modulation of the pulse width conducted by the prior art.

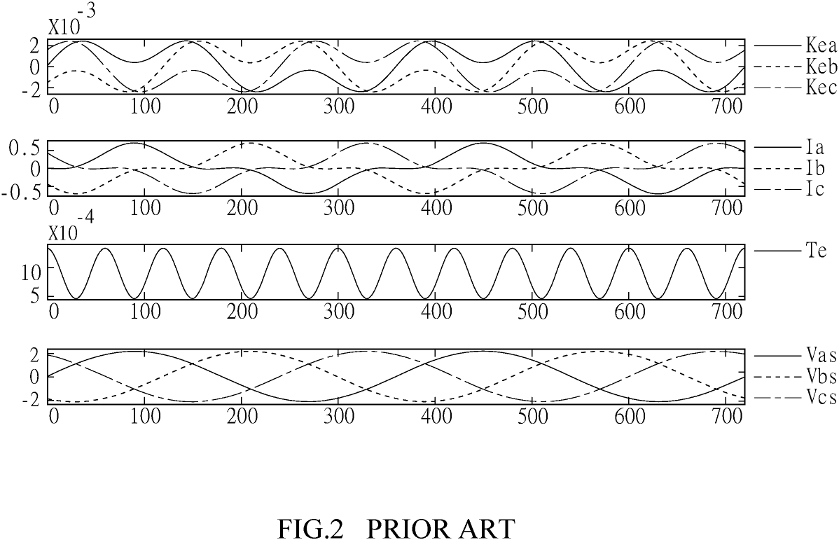

FIG. 3 is a circuit structure diagram of a preferred embodiment of the motor control system according to the invention.

FIG. 4 is a circuit diagram of the inverter circuit of a preferred embodiment of the motor control system according to the invention.

FIG. 5 is an operational view of the pulse modulation part of a preferred embodiment of the motor control system according to the invention.

FIG. 6A and FIG. 6B are waveform curves of the terminal voltages and phase voltages during modulation of the pulse width when 3-phase harmonic voltage is introduced into the preferred embodiment of the invention and the weight values of the harmonic wave is 0.1.

FIG. 7A and FIG. 7B are waveform curves of the terminal voltages and phase voltages during modulation of the pulse width when 3-phase harmonic voltage is introduced into the preferred embodiment of the invention and the weight values of the harmonic wave is -0.1.

FIG. 8 is the torque wave of the running motor during modulation of the pulse width when 3-phase harmonic voltage is introduced into the preferred embodiment of the invention and the weight values of the harmonic wave is 0.1.

FIG. 9 is the torque wave of the running motor during modulation of the pulse width when 3-phase harmonic voltage is introduced into the preferred embodiment of the invention and the weight values of the harmonic wave is -0.1.

FIG. 10 is a relationship diagram showing the relationship between the duty ratio of the modulation order input to the preferred embodiment of the invention, the duty ratio of the output pulse, and the target speed of the modulation signal, wherein the lateral axis is duty ratio of the modulation order, and the longitudinal axis is motor speed.

FIG. 11 is a waveform curve of the terminal voltages and phase voltages during modulation of the pulse width when 3-phase harmonic voltage is introduced into the preferred embodiment of the invention and the weight values of the harmonic wave is 0.1, when a voltage saturation limit is formed, and the modulation coefficient is 1.

FIG. 12 is a waveform curve of the terminal voltages and phase voltages during modulation of the pulse width when 3-phase harmonic voltage is introduced into the preferred embodiment of the invention and the weight values of the harmonic wave is 0.5, when a voltage saturation limit is formed, and the modulation coefficient is 1.

FIG. 13 is a modulated waveform curve of the terminal voltages and phase voltages during modulation of the pulse width when 3-phase harmonic voltage is introduced into the preferred embodiment of the invention and the weight values of the harmonic wave is 0.5, when a voltage saturation limit is formed, and the modulation coefficient is 1.5.

FIG. 14 is a flow chart of the method for correcting the motor control system according to a preferred embodiment of the invention.

FIG. 15 is a schematic view of the correcting structure of the method for correcting the motor control system according to a preferred embodiment of the invention.

### DETAILED DESCRIPTION OF THE INVENTION

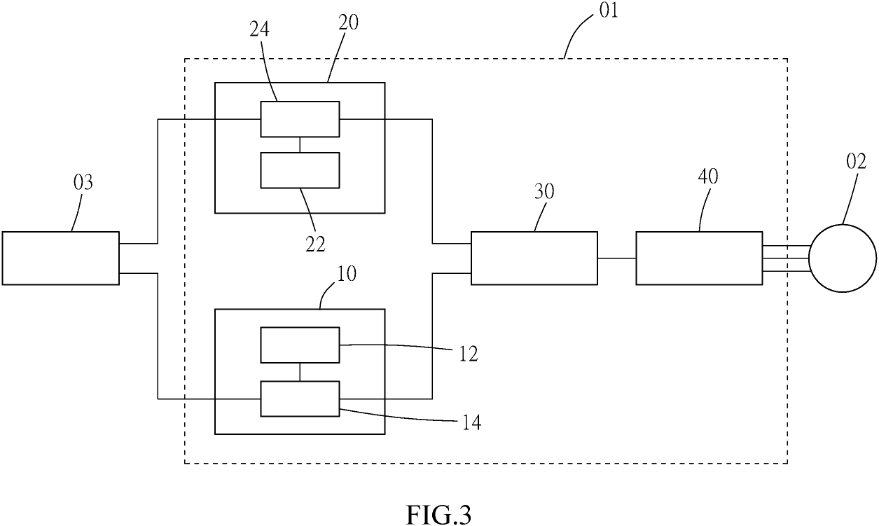

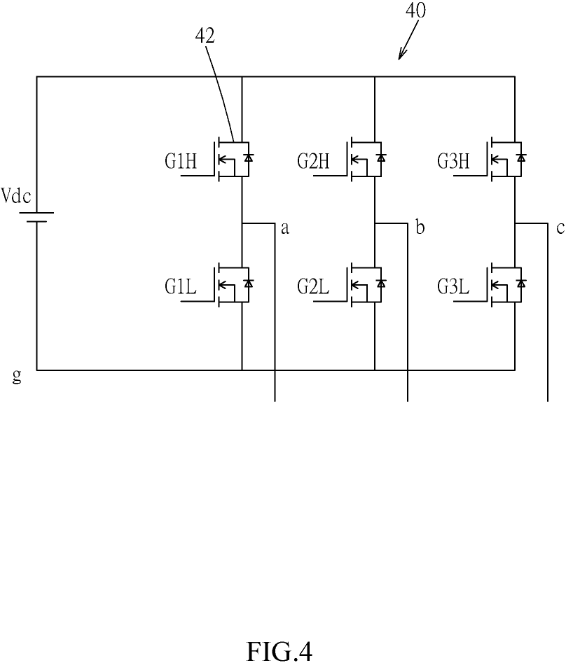

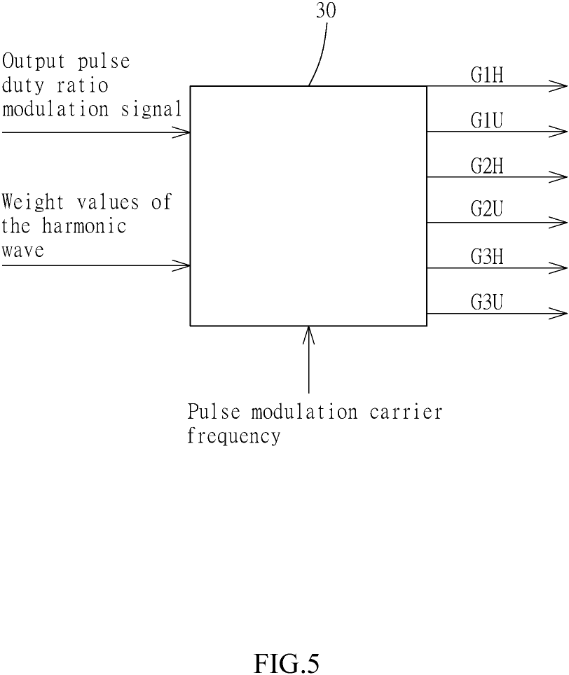

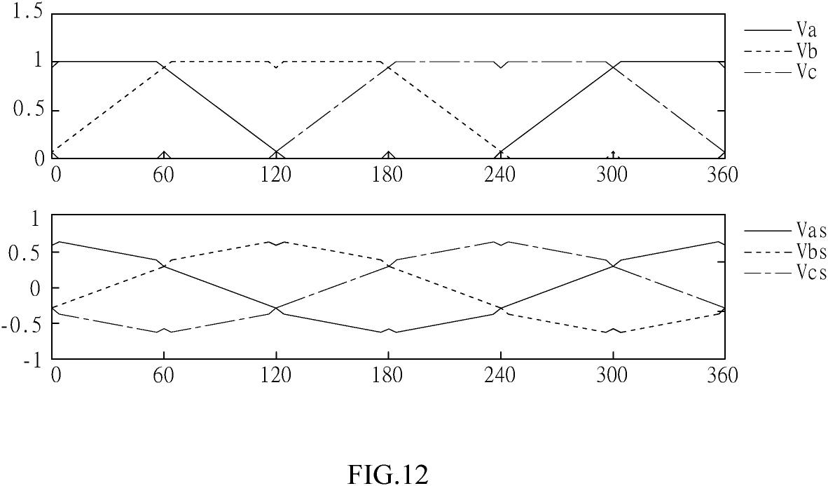

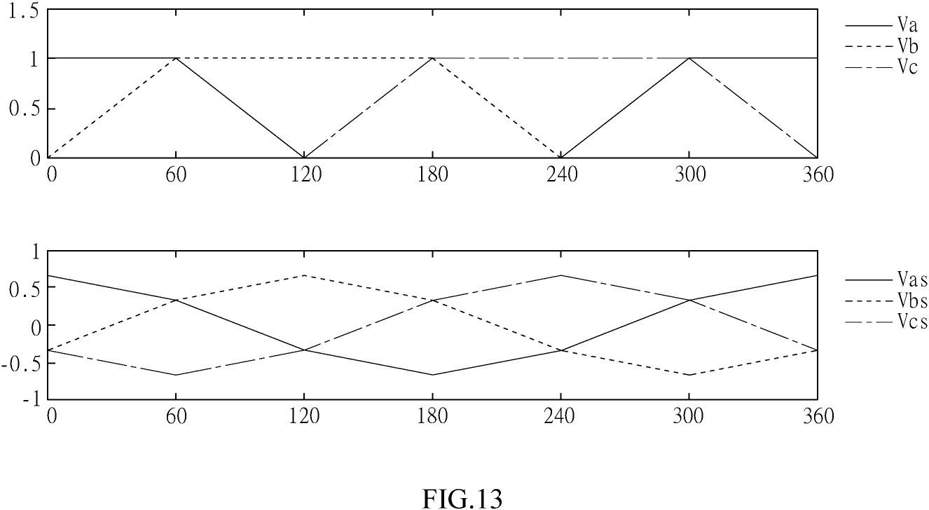

FIG. 3 to FIG. 15 are illustrations of the preferred embodiment of the motor control system with adjustable voltage harmonic and method for correcting the motor control system according to the invention.

Referring to FIG. 3 to FIG. 5, the motor control system with adjustable voltage harmonic 01 drives and controls a motor 02 on the basis of the input modulation order. The motor control system 01 includes a harmonic voltage weight selection unit 10, a modulation signal selection unit 20, a pulse modulation part 30 and an inverter circuit 40, wherein the harmonic voltage weight selection unit 10 is mainly made up of electronic circuits. The harmonic voltage weight selection unit 10 includes a first storage part 12 and a first selection part 14, the first storage part 12 is connected to the first selection part 14, the first storage part 12 is used to store a plurality of weight values of the harmonic waves of the harmonic voltage. The weight values of the harmonic wave define the ratio between the voltage harmonic peak and the basic voltage frequency peak. Based on the duty ratio instructed by the modulation order, the first selection part 14 selects the weight values of the harmonic wave corresponding to the harmonic voltage to be generated.

The modulation signal selection unit 20 is mainly made up of electronic circuits. The modulation signal selection unit 20 includes a second storage part 22 and a second selection part 24. The second storage part 22 is connected to the second selection part 24. The second storage part 22 is used to store a plurality of output pulse duty ratio modulation signals. Based on the duty ratio instructed by the modulation order, the second selection part 24 selects the corresponding output pulse duty ratio modulation signals.

Logic circuits are examples of the first selection part 14 and the second selection part 24. The first selection part 14 and the second selection part 24 are not limited to logic circuits.

The pulse modulation part 30 is mainly made up of electronic circuits. The pulse modulation part 30 is connected to the first selection part 14 and the second selection part 24. The pulse modulation part 30 is used to receive the weight values of the harmonic wave and the output pulse duty ratio modulation signals. Based on the weight values of the harmonic wave, the output pulse duty ratio modulation signal, and the externally input pulse modulation carrier frequency signal, a plurality of control signals are generated.

The inverter circuit 40 is connected to the pulse modulation part 30 and the motor 02. The inverter circuit 40 includes a plurality of electronic power switches 42. The inverter circuit 40 is used to receive the control signal. The electronic power switches 42 are actuated based on the control signal, adding the harmonic voltage into the motor-driving voltage, so as to drive the motor 02 to run.

The aforesaid preferred embodiment, the motor control system 01 can be used to control the motor 02. A three-phase permanent magnet motor is a preferred example of the motor 02. The motor control system 01 can also be used to control other forms of motors. When the motor control system 01 is used to control the motor 02, the motor control system 01 is connected to an order generating device 03. The order generating device 03 is mainly made up of electronic circuits. The order generating device 03 is used to generate the modulation order. The harmonic voltage weight selection unit 10 and the modulation signal selection unit 20 are respectively coupled to the order generating device 03. Based on the modulation order generated by the order generating device 03, the motor control system 01 controls the speed or torque of the running motor 02.

The harmonic voltage is a 3-phase harmonic voltage, or a 5-phase harmonic voltage, or a 7-phase harmonic voltage, or a combination thereof. The weight values of the harmonic wave are positive values, negative values, or zero. The weight values of the harmonic wave come from the correcting tests to reduce noise or vibration during the OFF-LINE operation state when the motor 02 is not connected to a load.

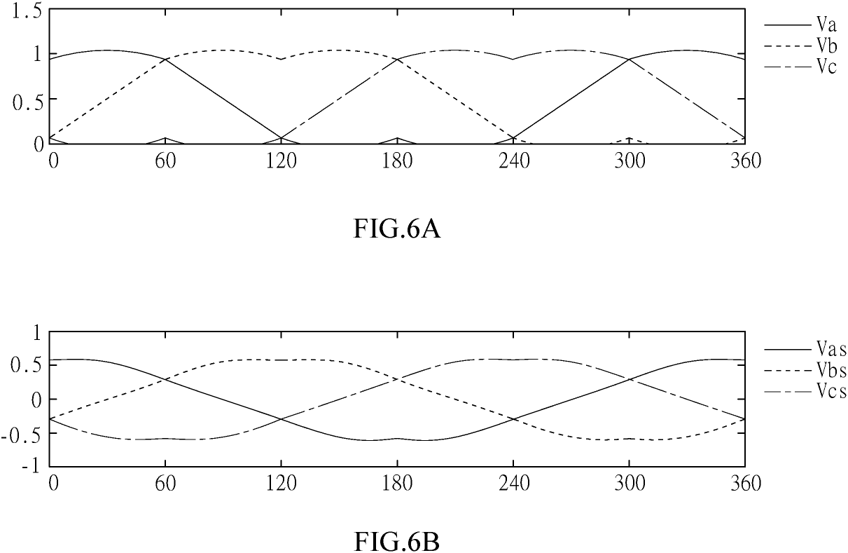

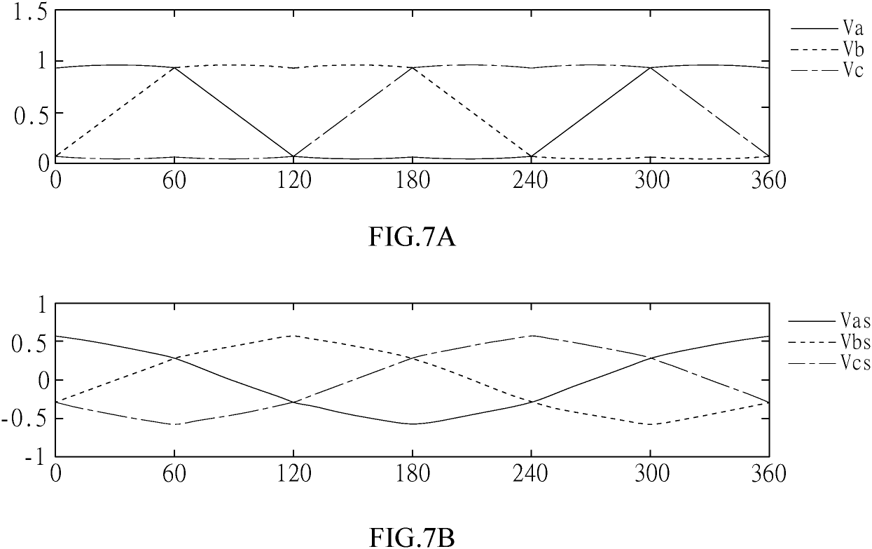

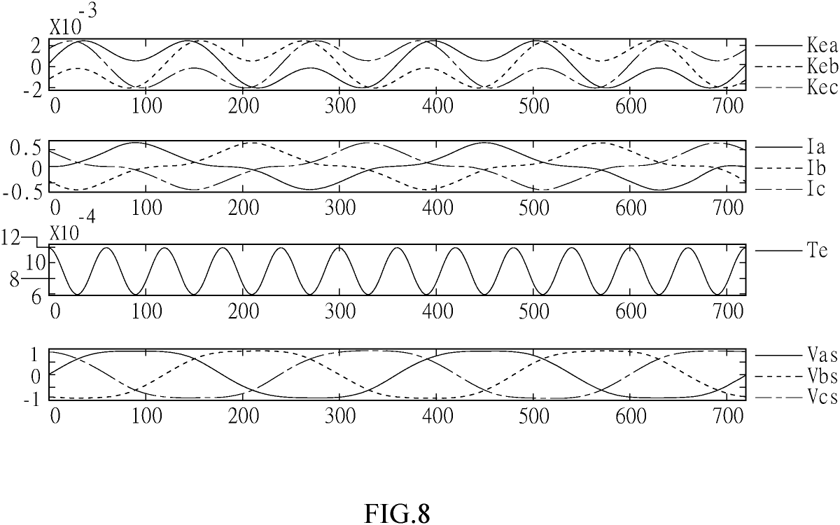

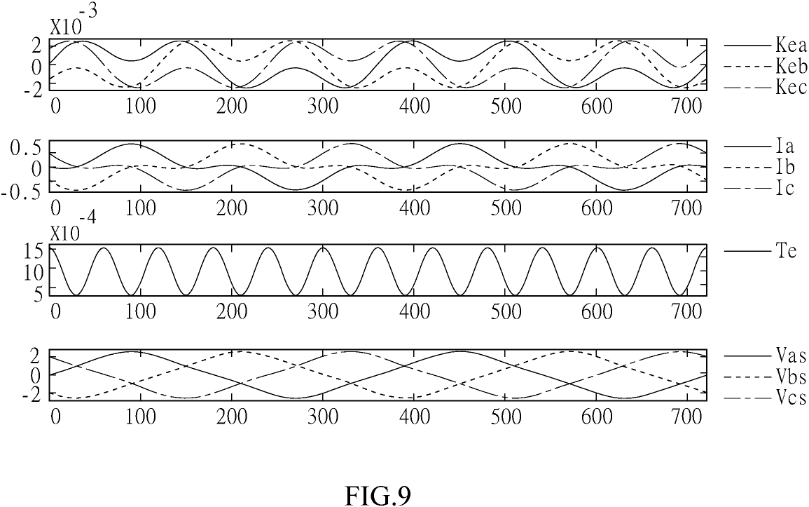

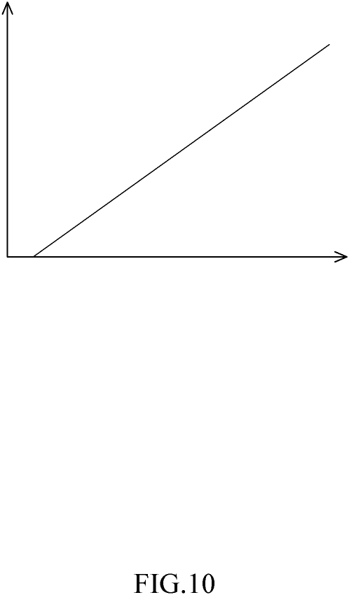

The plurality of weight values of the harmonic waves stored by the first storage part 12 are respectively corresponding to different duty ratios. The plurality of output pulse duty ratio modulation signals stored by the second storage part 22 are respectively corresponding to different duty ratios. Based on the weight values of the harmonic wave corresponding to the modulation order and the output pulse duty ratio modulation signal, as well as the pulse modulation carrier frequency signal, the pulse modulation part 30 generates the plurality of control signals. Each of the control signals respectively controls each of the electronic power switches 42 to adjust the current waveform that drives the motor 02. The current waveform is not limited to sine wave. According to the prior art, three-phase currents without harmonic wave is optimum selection to drive the motor. The means of the prior art to control the operation of the motor is removing the harmonic wave in the three-phase currents; As shown in FIG. 6A, FIG. 6B, FIG. 7A, FIG. 7B, FIG. 8 and FIG. 9, Based on the duty ratio of the modulation order, the preferred embodiment appropriately adds 3, 5, 7-phase harmonic waves into the phase currents, to control the torque variation of the motor 02, and to improve the phenomenon of torque ripple of the motor 02, thus reducing noise and vibration caused by torque ripple. Meanwhile, because of the change of the phase voltage, it also reduces noise and vibration caused by magnetic disturbance in the axial direction and the eccentricity between the stator and the rotor of the motor 02. By adjusting the relationship between the output pulse duty ratio modulation signal and the duty ratio of the modulation order, the preferred embodiment meets the linear requirements of the two physical quantities shown in FIG. 10.

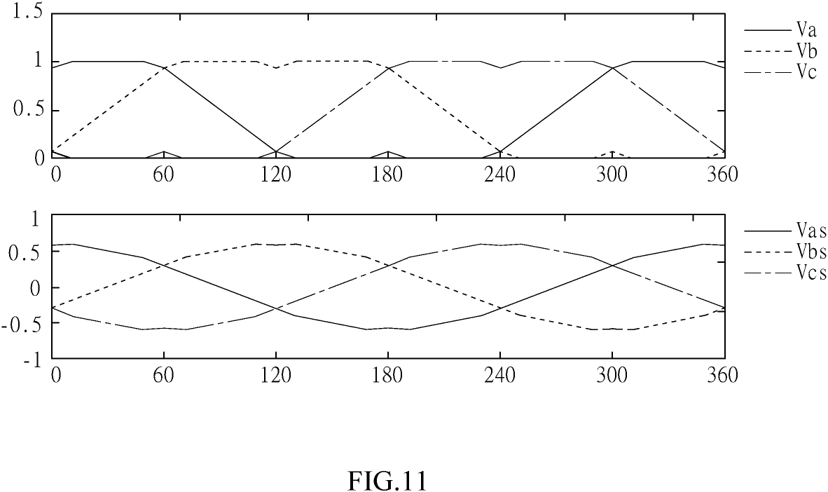

Referring to FIG. 11 to FIG. 13, during high-speed operation of the motor 02, the modulated voltage tends to be saturated, and the voltage waveform is gradually transformed from a similarly M wave to a trapezoidal wave, which enhances the voltage utilization ratio and increases the maximum speed of the motor 02.

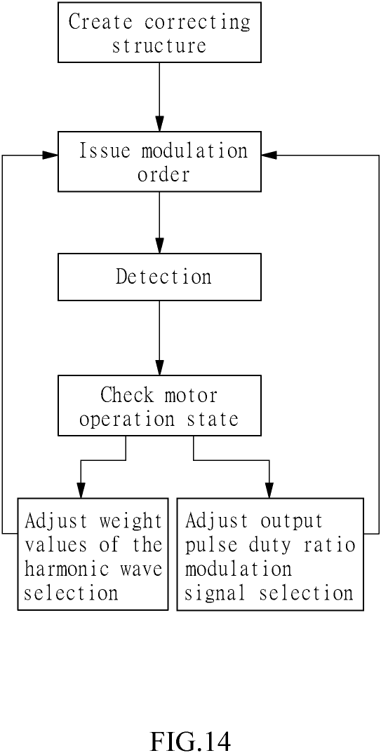

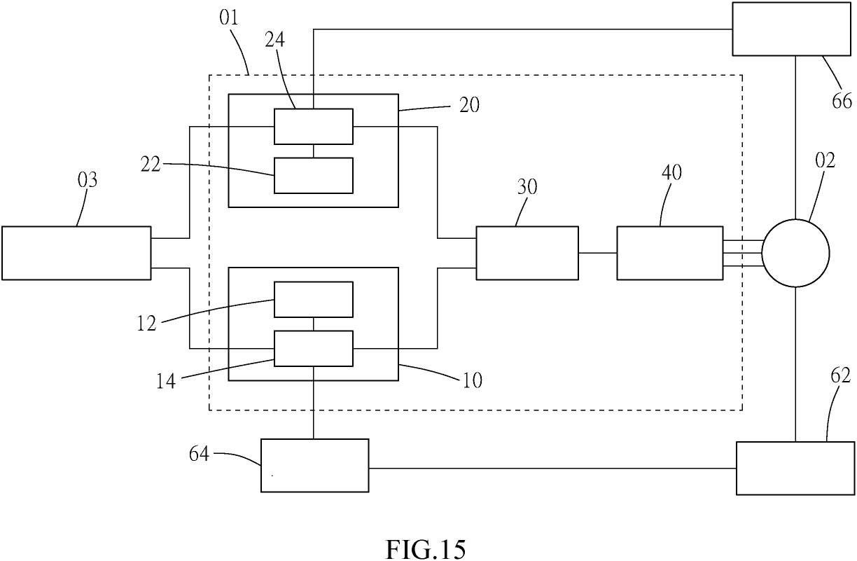

Referring to FIG. 14 and FIG. 15, the method for correcting the motor control system 01 is mainly used for correcting the harmonic voltage weight selection unit 10, so that the plurality of weight values of the harmonic waves stored by the harmonic voltage weight selection unit 10 can be respectively adapted to multiple operational requirements of the motor 02. Thus, the motor control system 01 can be adapted to the motor 02, and when needed, can be used to correct the modulation signal selection unit 20, so that the plurality of output pulse duty ratio modulation signals stored by the modulation signal selection unit 20 can be respectively adapted to multiple operational requirements of the motor 02. Thus, the motor control system 01 can be adapted to the motor 02.

The method for correcting the motor control system 01 includes the following steps:

Creating the correcting structure: The motor 02 is configured with a first detector 62. The first detector 62 is used to detect the vibration or noise of the running motor 02, and to generate a first operating signal. The first operating signal is vibration signal or noise signal. The first detector 62 is connected to a correcting device 64. The correcting device 64 is mainly made up of electronic circuits containing a microprocessor with executable programs. The motor control system 01 includes the harmonic voltage weight selection unit 10, the modulation signal selection unit 20, the pulse modulation part 30, and the inverter circuit 40, wherein the harmonic voltage weight selection unit 10 and the modulation signal selection unit 20 are respectively coupled to the order generating device 03. The harmonic voltage weight selection unit 10 is connected to the correcting device 64. The correcting device 64 is used to correct the selection of the plurality of weight values of the harmonic waves stored by the harmonic voltage weight selection unit 10 corresponding to different modulation orders. The inverter circuit 40 is connected to the motor 02.

Issuing a modulation order: The order generating device 03 issues the modulation order to the motor control system 01.

Detection: The first detector 62 detects the operation state of the motor 02, and generates the first operating signal.

Checking the motor operation state: Based on the first operating signal indicating the vibration or noise, the correcting device 64 judges if the performance of vibration or noise generated during operation of the motor 02 meets the anticipation of the modulation order.

Adjusting weight values of the harmonic wave selection: If the vibration or noise performance of the motor 02 meets the anticipation of the modulation order, the correcting device 64 maintains the selection of the harmonic voltage weight selection unit 10 based on the weight values of the harmonic wave corresponding to the modulation order. If the vibration or noise performance of the motor 02 does not meet the anticipation of the modulation order, the correcting device 64 removes the selection of the harmonic voltage weight selection unit 10 based on the weight values of the harmonic wave corresponding to the modulation order.

Repeatedly executing the step to issue a modulation order, the detecting step, the step to check the motor operation state, and the selection step to modulate the weight of the harmonic wave. Thus, the motor control system 01 can be adapted to the motor 02.

Executing the selection step to modulate the weight of the harmonic wave. When the selection of weight values of the harmonic wave by the harmonic voltage weight selection unit 10 based on the modulation order is maintained, and the step is executed again to issue a modulation order, a different modulation order is issued to the motor control system 01; When executing the selection step to modulate the weight of the harmonic wave to remove the selection of weight values of the harmonic wave selected by the harmonic voltage weight selection unit 10 based on the modulation order, and the step is executed again to issue a modulation order, the same modulation order is issued to the motor control system 01. Thus, the weight values of the harmonic wave stored by the harmonic voltage weight selection unit 10 is adjusted to be adapted to the modulation order.

During the step to control the motor operation, the inverter circuit 40 drives the motor 02 to run in the offline state. The inverter circuit 40 can also drive the motor 02 to run in the state with load connection. The load is determined by the usage of the motor 02. Fan blades are an example of the load.

When the method for correcting the motor control system 01 further corrects the modulation signal selection unit 20, during the step to create the correcting structure, the motor 02 is further configured with a second detector 66, the second detector 66 is used to detect the speed or torque of the running motor 02, and to generate a second operating signal. The second operating signal is speed signal or torque signal. The second selection part 24 is connected to the second detector 66. During the detecting step, the second detector 66 detects the operation state of the motor 02, and generates the second operating signal. In the step to check the motor operation state, based on the second operating signal, the second selection part 24 judges if the speed and torque of the motor 02 meets the anticipation of the modulation order.

After completion of the step to check the motor operation state, execute the step to adjust the selection of the output pulse duty ratio modulation signal. In the step to adjust the selection of the output pulse duty ratio modulation signal, if the speed and torque of the motor 02 meets the anticipation of the modulation order, the second selection part 24 maintains the corresponding selection of the output pulse duty ratio modulation signal based on the modulation order. If the speed and torque of the motor 02 does not meet the anticipation of the modulation order, the second selection part 24 removes the corresponding selection of the output pulse duty ratio modulation signal based on the modulation order.

Repeatedly executing the step to issue a modulation order, the detecting step, the step to check the motor operation state, and the step to adjust the selection of the output pulse duty ratio modulation signal. Thus, the motor control system 01 can be adapted to the motor 02.

When executing the step to adjust the selection of the output pulse duty ratio modulation signal, the corresponding selection of the output pulse duty ratio modulation signal based on the modulation order is maintained, and the step to issue a modulation order is executed again, a different modulation order is issued to the motor control system 01; When executing the step to adjust the selection of the output pulse duty ratio modulation signal, the corresponding selection of the output pulse duty ratio modulation signal based on the modulation order is removed, and the step to issue a modulation order is executed again, the same modulation order is issued to the motor control system 01. Thus, the output pulse duty ratio modulation signal stored in the modulation signal selection unit 20 is adjusted to be adapted to the modulation order.

As needed, the method for correcting the motor control system 01 may only execute the selection step to modulate the weight of the harmonic wave or the step to adjust the output pulse duty ratio modulation signal. In this case, a different implementation of the selection is formed.

The components of motors 02 of the same specifications produced by the same manufacturer may come from different suppliers. Even if the components come from the same suppliers, there may be slight differences between different production batches, and the operation state of the motors 02 produced in different batches may also differ. Through the above-described correcting method, the motor control system 01 can be adapted to a motor 02 from a specific production batch, thus solving the problem that the motor control system 01 may not be adapted to motors 02 from different production batches.

We claim:

1. A motor control system with adjustable voltage harmonic drives and controls a motor on the basis of the input modulation order, said motor control system including:
a harmonic voltage weight selection unit, including a first storage part and a first selection part, wherein, the first storage part is connected to the first selection part, the first storage part is used to store a plurality of weight values of the harmonic waves of the harmonic voltage, based on the duty ratio instructed by the modulation order, the first selection part selects the weight values of the harmonic wave corresponding to the harmonic voltage to be generated;
a modulation signal selection unit, said modulation signal selection unit including a second storage part and a second selection part, wherein said second storage part is connected to the second selection part, said second storage part is used to store a plurality of output pulse duty ratio modulation signals, based on the duty ratio instructed by the modulation order, the second selection part selects the corresponding output pulse duty ratio modulation signal;
a pulse modulation part, connected to the first selection part and the second selection part, which is used to receive the weight values of the harmonic wave and the output pulse duty ratio modulation signal, based on the weight values of the harmonic wave, the output pulse duty ratio modulation signal, and the externally input pulse modulation carrier frequency signal, a plurality of control signals are generated; and
an inverter circuit, connected to the pulse modulation part and the motor, wherein said inverter circuit includes a plurality of electronic power switches, and is used to receive the control signal, the electronic power switches are actuated based on the control signal, adding the harmonic voltage into the motor-driving voltage, so as to drive the motor to run;
wherein the weight values of the harmonic wave define the ratio between the voltage harmonic peak and the basic voltage frequency peak.

2. The motor control system defined in claim 1, wherein said harmonic voltage is a 3-phase harmonic voltage, or a 5-phase harmonic voltage, or a 7-phase harmonic voltage, or a combination thereof.

3. The motor control system defined in claim 1, wherein said weight values of the harmonic wave are positive values, negative values, or zero.

4. A method for correcting the motor control system defined in claim 1, used to adapt the motor control system to a motor; said method includes the following steps:
creating a correcting structure: The motor is configured with a first detector, the first detector is used to detect the vibration or noise of the running motor, and to generate a first operating signal, the first detector is connected to a correcting device, the motor control system includes a harmonic voltage weight selection unit, a modulation signal selection unit, a pulse modulation part and an inverter circuit, wherein the modulation signal selection unit and the harmonic voltage weight selection unit are respectively coupled with a generating device, the order generating device is used to generate a modulation order, the harmonic voltage weight selection unit is connected to the correcting device, the correcting device is used to adjust the selection of weight values of the harmonic wave corresponding to the modulation order, the harmonic voltage weight selection unit and the modulation signal selection unit are respectively connected to the pulse modulation part, the pulse modulation part is connected to the inverter circuit, the inverter circuit is connected to the motor, the harmonic voltage weight selection unit stores a plurality of weight values of the harmonic waves of the harmonic voltage, the harmonic voltage weight selection unit includes a first selection part, the first selection part is used to select the corresponding weight values of the harmonic wave based on the modulation order, based on the duty ratio instructed by the modulation order, the modulation signal selection unit is used to select the corresponding output pulse duty ratio modulation signal, based on the weight values of the harmonic wave, the output pulse duty ratio modulation signal, and the externally input pulse modulation carrier frequency signal, the pulse modulation part generates a plurality of control signals, based on the control signal, the inverter circuit drives the motor to run;
issuing a modulation order: the order generating device issues the modulation order to the motor control system;
detection: the first detector detects the vibration or noise of the running motor, and to generates the first operating signal;
checking motor operation state: based on the first operating signal, the correcting device judges if the vibration or noise performance of the motor meets the anticipation of the modulation order;
adjusting weight values of the harmonic wave selection: if the vibration or noise performance of the motor meets the anticipation of the modulation order, the correcting device maintains the selection of the harmonic voltage weight selection unit based on the weight values of the harmonic wave corresponding to the modulation order, if the vibration or noise performance of the motor does not meet the anticipation of the modulation order, the correcting device removes the selection of the harmonic voltage weight selection unit based on the weight values of the harmonic wave corresponding to the modulation order;
repeatedly executing the step to issue a modulation order, the detecting step, the step to check the motor operation state, and the selection step to modulate the weight of the harmonic wave, thus, the motor control system can be adapted to the motor;
wherein, when executing the selection step to modulate the weight of the harmonic wave, the selection of weight values of the harmonic wave by the harmonic voltage weight selection unit based on the modulation order is maintained, and the step to issue a modulation order is executed again, a different modulation order is issued to the motor control system;
when executing the selection step to modulate the weight of the harmonic wave, the selection of weight values of the harmonic wave by the harmonic voltage weight selection unit based on the modulation order is removed, and the step to issue a modulation order is executed again, the same modulation order is issued to the motor control system, thus, the weight values of the harmonic wave stored by the harmonic voltage weight selection unit is adjusted to be adapted to the modulation order.

5. The method for correcting the motor control system defined in claim 4, wherein, during the step to create the correcting structure, the motor is further configured with a second detector, the second detector is used to detect the speed or torque of the running motor, and to generate a second operating signal, the second selection part is connected to the second detector, in the detecting step, the second detector detects the operation state of the motor, and generates the second operating signal, in the step to check the motor operation state, based on the second operating signal, the second selection part judges if the speed or torque of the motor meets the anticipation of the modulation order;
after completion of the step to check the motor operation state, executing the step to adjust the selection of the output pulse duty ratio modulation signal, in the step to adjust the selection of the output pulse duty ratio modulation signal, if the speed or torque of the motor meets the anticipation of the modulation order, the second selection part maintains the corresponding selection of the output pulse duty ratio modulation signal based on the modulation order, if the speed or torque of the motor does not meet the anticipation of the modulation order, the second selection part removes the corresponding selection of the output pulse duty ratio modulation signal based on the modulation order;
repeatedly executing the step to issue a modulation order, the detecting step, the step to check the motor operation state, and the step to adjust the selection of the output pulse duty ratio modulation signal, thus, the motor control system can be adapted to the motor;
when executing the step to adjust the selection of the output pulse duty ratio modulation signal, the corresponding selection of the output pulse duty ratio modulation signal based on the modulation order is maintained; when executing again the step to issue a modulation order, a different modulation order is issued to the motor control system; when executing the step to adjust the selection of the output pulse duty ratio modulation signal, the corresponding selection of the output pulse duty ratio modulation signal based on the modulation order is removed; when executing again the step to issue a modulation order, the same modulation order is issued to the motor control system, thus, the output pulse duty ratio modulation signal stored in the modulation signal selection unit is adjusted to be adapted to the modulation order.

6. The method for correcting the motor control system defined in claim 4, wherein, during the step to control the motor operation, the inverter circuit drives the motor to run in the offline state.
